(19) United States
(12) Patent Application Publication
(10) Pub. No.: US 2025/0290698 A1
(43) Pub. Date: Sep. 18, 2025

(54) GROOVED FLOW CHANNEL WITH POROUS INSERT FOR SPACE RADIATOR CONDENSING

(71) Applicant: Hamilton Sundstrand Space Systems International, Inc., Windsor Locks, CT (US)

(72) Inventor: Wei-Lin Cho, Unionville, CT (US)

(21) Appl. No.: 18/795,292

(22) Filed: Aug. 6, 2024

Related U.S. Application Data
(60) Provisional application No. 63/565,766, filed on Mar. 15, 2024.

(51) Int. Cl. F28D 7/16; F28F 9/02

(52) U.S. Cl. CPC F28D 7/163; F28F 9/02

(57) ABSTRACT

A fluid flow pathway of a radiator includes a flow channel having an inlet end and an outlet end. The flow channel includes a plurality of grooves extending in a lengthwise direction along an interior of the flow channel. Each groove extends from a groove base to a groove apex radially outboard of the groove base. A main channel is defined radially between the groove bases of the plurality of grooves. The fluid flow pathway includes an outlet header to which flow channel is installed at a header channel, and a porous insert positioned between the flow channel and the header channel to regulate a flow of fluid into the outlet header from the flow channel.

### CROSS-REFERENCE TO RELATED APPLICATIONS

This application claims the benefit of U.S. Application No. 63/565,766 filed Mar. 15, 2024, the disclosure of which is incorporated herein by reference in its entirety.

### BACKGROUND

Exemplary embodiments pertain to the art of thermal energy rejection from spacecraft.

In space applications, waste heat generated by the spacecraft is normally rejected through the space radiator. In some cases, vapor or two-phase fluid enters a space radiator flow channels through the inlet header. After entering the flow channels, the energy is transferred from the hot fluid to the cold flow channel walls. After the heat is removed from the vapor or the two-phase flow, the hot fluid condenses back to liquid phase. The resident time of the vapor or the two-phase flow inside the flow channels, the size of the contact area between the vapor or the two-phase flow and the flow channels, and the vapor or two-phase flow distribution in the multiple flow channels are important factors in determining the radiator efficiency.

For a space radiator with multiple parallel flow passages, orifices are commonly used to create desired back pressure to achieve uniform flow distribution. Another way to achieve uniform flow distribution is to design a large manifold to space radiator flow channel area ratio.

The flow direction inside the passage is strongly affected by the gravity. In the gravity field, the liquid moves towards the direction of gravity. In a microgravity environment, such as a space environment, the fluid tends to move straight after flowing through the header if there is no disturbance. In this case, the vapor or two-phase flow will have less opportunity to have good contact with the condenser wall which results in a low condenser operating efficiency.

### BRIEF SUMMARY

In one exemplary embodiment, a fluid flow pathway of a radiator includes a flow channel having an inlet end and an outlet end. The flow channel includes a plurality of grooves extending in a lengthwise direction along an interior of the flow channel. Each groove extends from a groove base to a groove apex radially outboard of the groove base. A main channel is defined radially between the groove bases of the plurality of grooves. The fluid flow pathway includes an outlet header to which flow channel is installed at a header channel, and a porous insert positioned between the flow channel and the header channel to regulate a flow of fluid into the outlet header from the flow channel.

Additionally or alternatively, in this or other embodiments the porous insert includes a base portion installed to the header channel, and a body portion installed into the outlet end of the flow channel. The body portion blocks the main channel of the flow channel.

Additionally or alternatively, in this or other embodiments the body portion includes a body ring extending radially outwardly, the body ring includes a plurality of ring openings configured to allow for a flow of fluid from the plurality of grooves therethrough.

Additionally or alternatively, in this or other embodiments the base portion includes a plurality of base grooves in fluid communication with the plurality of ring openings.

Additionally or alternatively, in this or other embodiments the body portion extends from the base portion to a conical body tip.

Additionally or alternatively, in this or other embodiments a groove of the plurality of grooves is defined by opposing groove sidewalls having a selected groove angle therebetween and converging at the groove apex.

Additionally or alternatively, in this or other embodiments the groove angle is selected such that liquid phase fluid flow expels vapor phase fluid flow from the plurality of grooves and into the main channel.

Additionally or alternatively, in this or other embodiments the fluid flow pathway includes an inlet header to which the flow channel is connected at the inlet end of the flow channel.

Additionally or alternatively, in this or other embodiments the porous insert is formed from a plurality of micro-sized particles bonded together via, one of sintering or by one or more additive manufacturing processes.

In another exemplary embodiment, a heat exchanger includes one or more fluid flow networks. Each fluid flow network includes a plurality of flow channels having an inlet end and an outlet end. At least one flow channel of the plurality of flow channels includes a plurality of grooves extending in a lengthwise direction along an interior of the flow channel. Each groove extends from a groove base to a groove apex radially outboard of the groove base. A main channel is defined radially between the groove bases of the plurality of grooves. The at least one flow channel includes an inlet header to which each inlet end is installed, and an outlet header to which each outlet end is installed at a respective header channel. A porous insert is positioned between the flow channel and the header channel to regulate a flow of fluid into the outlet header from the flow channel.

Additionally or alternatively, in this or other embodiments the porous insert includes a base portion installed to the header channel, and a body portion installed into the outlet end of the flow channel. The body portion blocks the main channel of the flow channel.

Additionally or alternatively, in this or other embodiments the body portion includes a body ring extending radially outwardly. The body ring includes a plurality of ring openings configured to allow for a flow of fluid from the plurality of grooves therethrough.

Additionally or alternatively, in this or other embodiments the base portion includes a plurality of base grooves in fluid communication with the plurality of ring openings.

Additionally or alternatively, in this or other embodiments the body portion extends from the base portion to a conical body tip.

Additionally or alternatively, in this or other embodiments a groove of the plurality of grooves is defined by opposing groove sidewalls having a selected groove angle therebetween and converging at the groove apex.

Additionally or alternatively, in this or other embodiments the groove angle is selected such that liquid phase fluid flow expels vapor phase fluid flow from the plurality of grooves and into the main channel.

Additionally or alternatively, in this or other embodiments the porous insert is formed from a plurality of micro-sized particles bonded together via, one of sintering or by one or more additive manufacturing processes.

Additionally or alternatively, in this or other embodiments a honeycomb material is positioned between adjacent flow channels of the plurality of flow channels.

Additionally or alternatively, in this or other embodiments one or more face sheets are in thermal communication with the plurality of flow channels.

Additionally or alternatively, in this or other embodiments the one or more fluid flow networks is two fluid flow networks.

### BRIEF DESCRIPTION OF THE DRAWINGS

The following descriptions should not be considered limiting in any way. With reference to the accompanying drawings, like elements are numbered alike:

FIG. 1 is an isometric view of an embodiment of a radiator panel with flow through flow network for space application;

FIG. 2 is a partially disassembled view of an embodiment of a radiator panel;

FIG. 3 is a cross-sectional view of an embodiment of a radiator panel;

FIG. 4 is a partial cross-sectional view of an individual flow line assembly to an inlet manifold;

FIG. 5 is an isometric view of an embodiment of a grooved flow channel;

FIG. 6 is a partial geometric representation of groove geometry of a grooved flow channel;

FIG. 7 illustrates movements of liquid and vapor inside an exemplary liquid-retaining groove of a grooved flow channel;

FIG. 8 illustrates an isometric view of a flow channel assembly to an outlet manifold;

FIG. 9 illustrates a first cross-sectional view of a porous insert installed in the outlet header of a flow through space radiator;

FIG. 10 illustrates a second cross-sectional view of a porous insert installed in the outlet header of a flow through space radiator;

FIG. 11 illustrates a partially disassembled view of the flow channel, insert, and header assembly;

FIG. 12 illustrates an isometric view of an embodiment of a porous insert; and

FIG. 13 illustrates a cross-sectional view of an embodiment of a porous insert.

### DETAILED DESCRIPTION

A detailed description of one or more embodiments of the disclosed apparatus and method are presented herein by way of exemplification and not limitation with reference to the Figures.

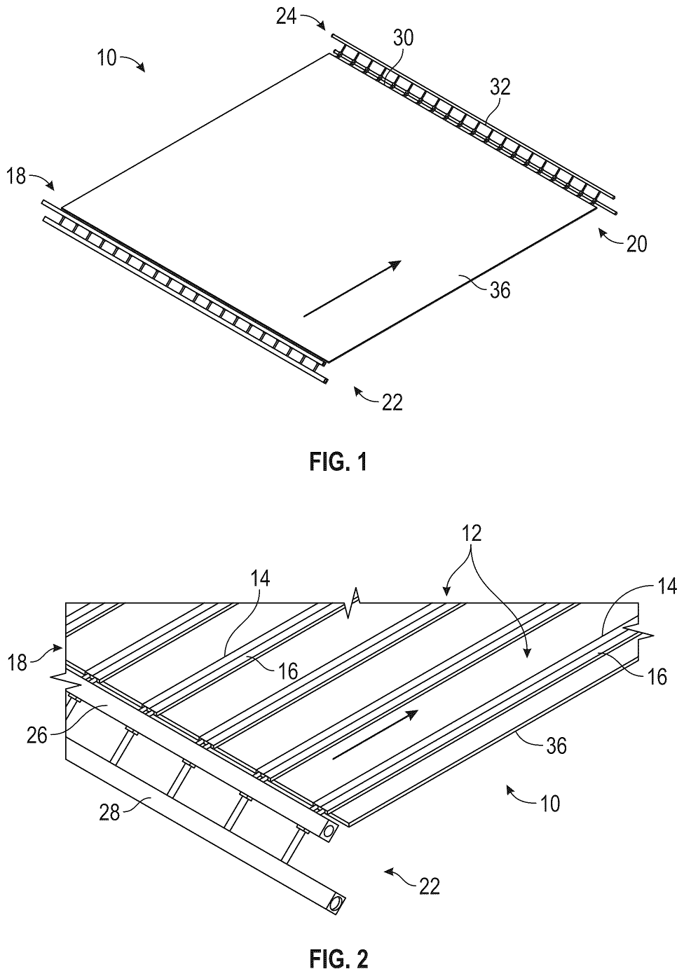

FIGS. 1 and 2 illustrate an embodiment of a radiator assembly 10 for, for example, extraplanetary or space operations. The radiator assembly 10 includes dual flow networks, defined by flow channel pairs 12 that include defined by a plurality of first flow channels 14 and a plurality of second flow channels 16, which are arranged in parallel to each other. In some embodiments a first flow channel 14 abuts a second flow channel 16, defining the flow channel pair 12. The flow channel pairs 12 extend from a radiator inlet 18 to a radiator outlet 20, with a flow of fluid directed along the first flow channels 14 and/or the second flow channels 16. In some embodiments, the flow of fluid enters the flow channels 14, 16 in vapor phase or as two-phase flow. As the fluid travels along the flow channels 14, 16, thermal energy in the fluid is radiated from the flow channels 14, 16, thus lowering a temperature of the fluid.

An inlet manifold system 22 is disposed at the radiator inlet 18, and an outlet manifold system 24 is disposed at the radiator outlet 20. The inlet manifold system 22 includes a first inlet manifold 26 fluidly connected to the plurality of first flow channels 14 and a second inlet manifold 28 fluidly connected to the plurality of second flow channels 16. Similarly, the outlet manifold system 24 includes a first outlet manifold 30 fluidly connected to the plurality of first flow channels 14, and a second outlet manifold 32 fluidly connected to the plurality of second flow channels 16. A first flow network therefore includes the first inlet manifold 26, the plurality of first flow channels 14 and the first outlet manifold 30. Similarly, a second flow network includes the second inlet manifold 28, the plurality of second flow channels 16 and the second outlet manifold 32. In some embodiments, the first flow network is the primary flow network for operation of the radiator 10, while the second flow network is a redundant or back-up flow network, which is operated when the first flow network is damaged or otherwise inoperable.

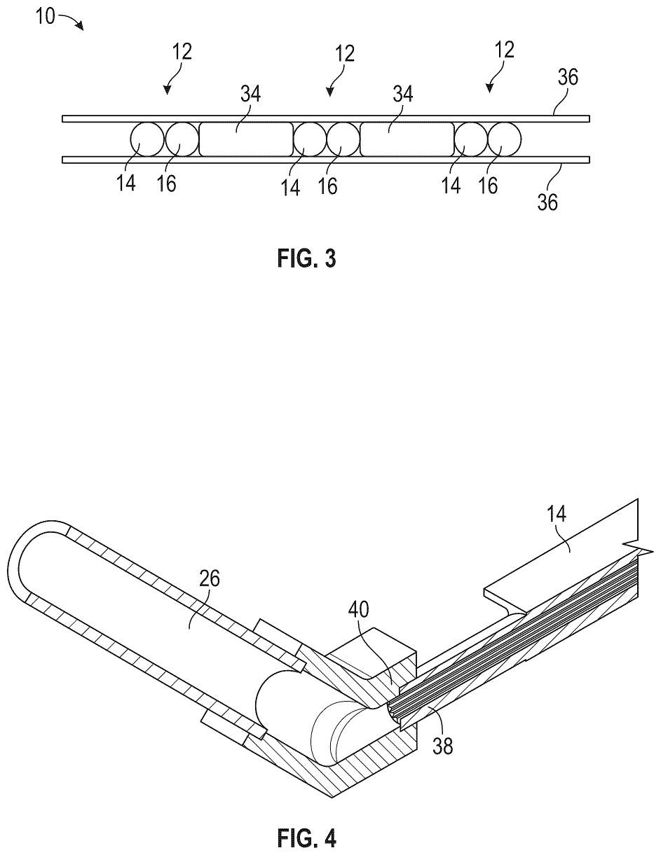

Referring to FIG. 2 and the cross-sectional view of FIG. 3, the flow channel pairs 12 are spaced apart across the radiator 10, with a filler structure, for example, a honeycomb element 34 disposed between adjacent flow channel pairs 12. The flow channel pairs 12 and the honeycomb elements 34 are sandwiched between face sheets 36, which in some embodiments are formed from aluminum. The face sheets 36 and the honeycomb elements 34 increase surface area leading to improved heat dissipation from the radiator 10. The thermal energy can be rejected from either side or both sides of the radiator panel.

Referring now to FIG. 4, illustrated is a connection of a first flow channel 14 to the first inlet manifold 26. The first flow channel 14 includes a channel end 38 that is installed into a complimentary manifold opening 40 of the first inlet manifold 26. While a connection of the first flow channel 14 to the first inlet manifold 26 is illustrated, one skilled in the art will readily appreciate that a similar connection may be utilized to connect the second flow channels 16 to the second inlet manifold 28.

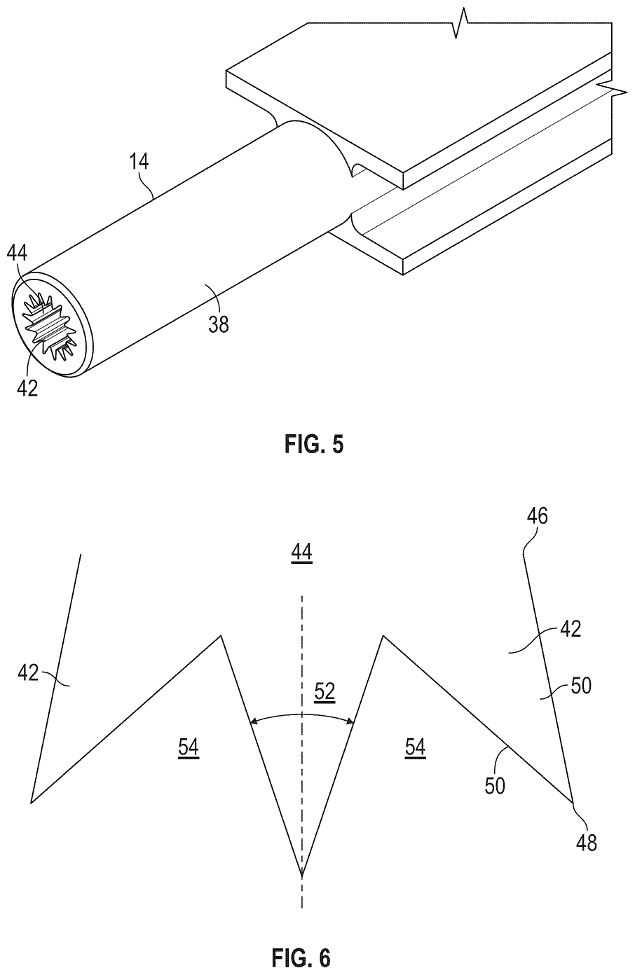

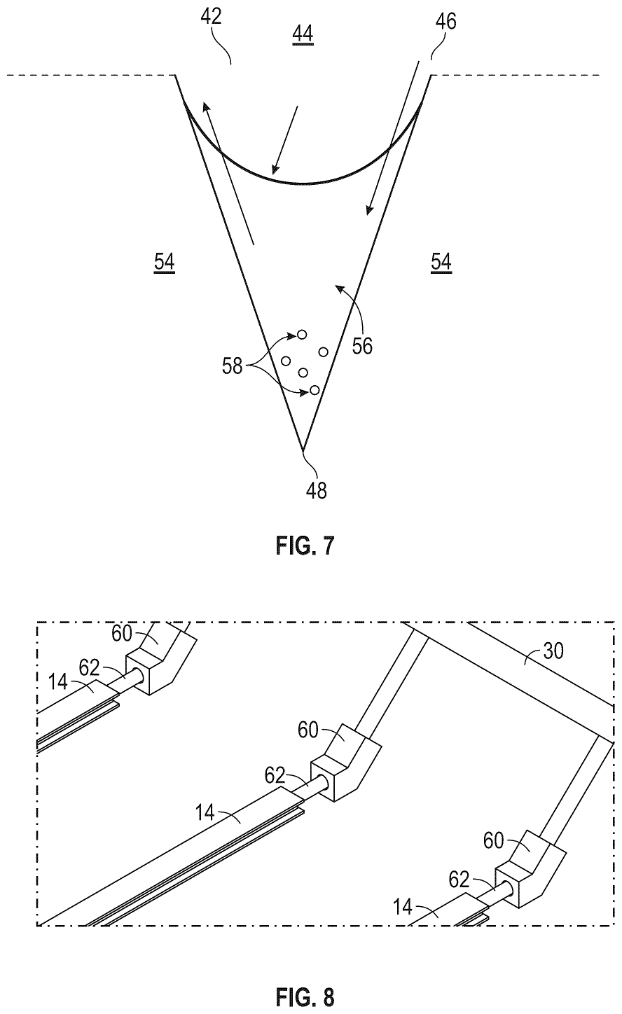

While the following description is in the context of a first flow channel 14, one skilled in the art will readily appreciate that the present description could be equally applied to second flow channels 16 of the radiator 10. As illustrated in FIG. 5, the first flow channels 14 have a plurality of channel grooves 42 in a channel interior 44 of the first flow channels 14. As illustrated in FIG. 6, the grooves 42 each extend from a groove base 46 to a groove apex 48, with groove sides 50 converging at the groove apex 48. The groove sides 50 are aligned at a groove opening angle 52, with respect to each other. The groove opening angle 52 is set to a predetermined contact angle between the channel solid surface 54 and the fluid in the fluid in the first flow channel 14. Referring now to FIG. 7, the groove opening angle 52 is selected so that the channel grooves 42 facilitates moving liquid phase fluid 56 from the groove base 46 toward the groove apex 48 and moving vapor phase fluid 58 away from the groove apex 48 and toward the groove base 46. The grooved flow channel 14 also provides an increased contact area between the hot fluid and the flow channel 14 compared to that of the smooth bore tube. The effect of the addition of the grooved channel 14 surface can be treated as an extended surface in a finned tube.

In a microgravity environment, the fluid tends to move straight after flowing through the inlet manifold 26 if there is no disturbance. In this case, the vapor or two-phase flow will have less opportunity to have good contact with the flow channel 14 wall which results in a low condensing efficiency. The channel grooves 42 increase the contact area and improve condensing efficiency of the radiator 10. To prevent vapor or two-phase flow from directly blowing through the flow line, porous inserts with restricted flow passages were designed and installed in the flow line outlet header. FIG. 8 shows the isometric view of flow channels 14 to the first outlet manifold 30. It is to be appreciated, however, that a similar arrangement may be utilized to connect the second flow channels 16 to the second outlet manifold 32. Each of the first flow channels 14 includes a channel outlet end 60 that is connected to the first outlet manifold 30 via a header 62 into which the channel outlet end 60 is installed.

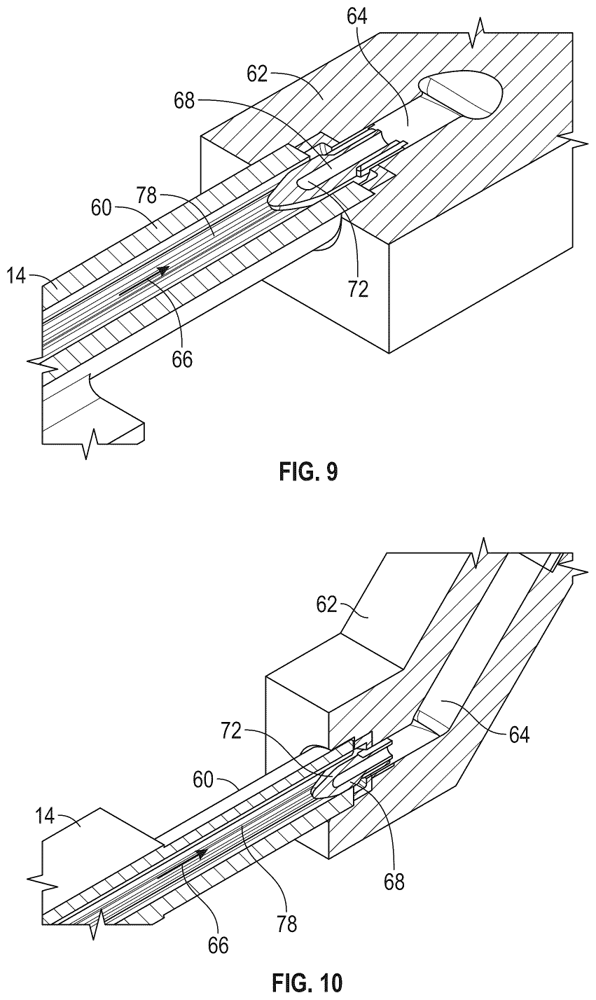

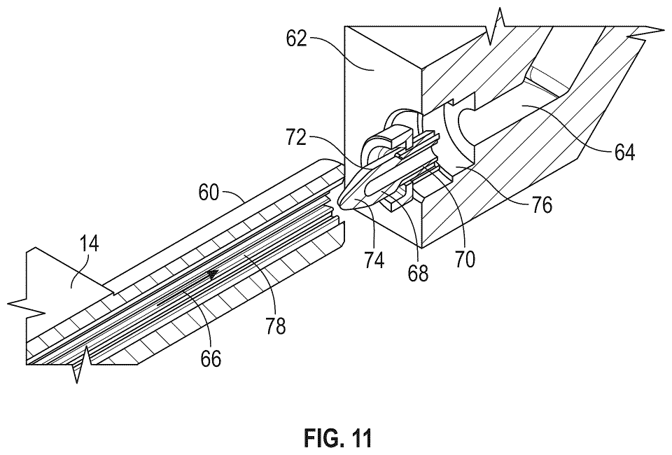

Referring now to the cross-sectional views of FIGS. 9 and 10 and the partially-disassembled view of FIG. 11, the header 62 includes a header channel 64 therein that directs the fluid 66 from the first flow channel 14 toward the first outlet manifold 30. The porous insert 68 is located between the channel outlet end 60 and the header channel 64 to control outflow of the fluid from the first flow channel 14 toward the first outlet manifold 30. The porous insert 68 includes an insert base portion 70 and an insert body portion 72, with the insert body portion 72 extending to a conical tip 74. The insert base portion 70 is installed into an insert recess 76 in the header 62, while the insert body portion 72 extends into the first flow channel 14 and blocks a center opening 78, radially between the groove bases 46 of the first flow channel 14.

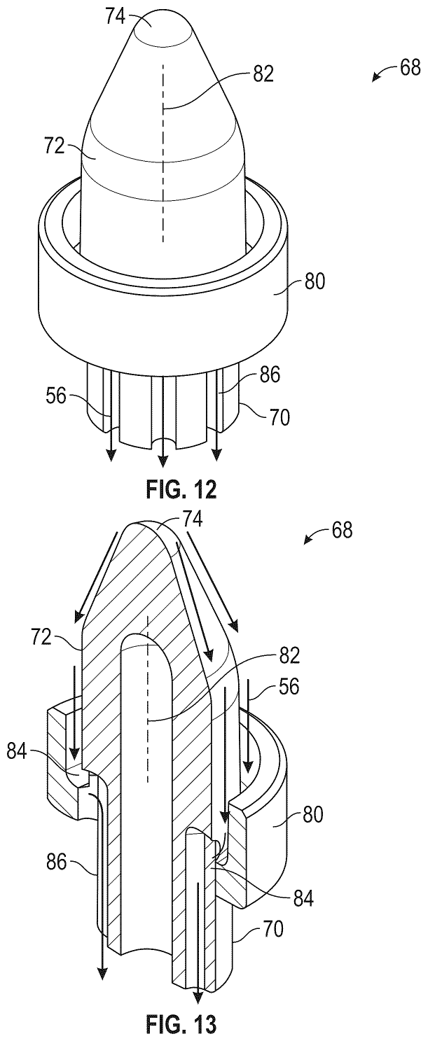

Referring now to FIGS. 12 and 13, the porous insert 68 is illustrated in greater detail. The insert base portion 72 includes a base ring 80 extending around an insert axis 82. The base ring 80 includes a plurality of ring openings 84. Since, as discussed earlier, the vapor phase fluid 58 is urged toward the groove base 46, and thus into the center opening 78, the insert body portion 72 blocks the vapor phase fluid 58 from exiting through the center opening 78, while the liquid phase fluid 56 passes through the ring openings 84 and toward the header channel 64 via base passages 86 in the insert base portion 70. The porous insert 68 is formed from a porous material, which in some embodiments is a plurality of micro-sized particles bonded together via, for example, sintering or by one or more additive manufacturing processes. The porous material defines multiple tortuous pathways through the porous insert 68, which allows the liquid phase fluid 56 to flow therethrough, but prevents vapor phase fluid 58 from passing therethrough.

The radiator 10 described herein, including the grooved flow channels 14, 16 and the porous insert 68, improves the operating efficiency of the radiator 10, especially when operated in a microgravity environment.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A fluid flow pathway of a radiator comprising:
a flow channel having an inlet end and an outlet end, the flow channel including:
a plurality of grooves extending in a lengthwise direction along an interior of the flow channel, each groove extending from a groove base to a groove apex radially outboard of the groove base; and
a main channel defined radially between the groove bases of the plurality of grooves;
an outlet header to which flow channel is installed at a header channel; and
a porous insert disposed between the flow channel and the header channel to regulate a flow of fluid into the outlet header from the flow channel.

2. The fluid flow pathway of claim 1, wherein the porous insert includes:
a base portion installed to the header channel; and
a body portion installed into the outlet end of the flow channel;
wherein the body portion blocks the main channel of the flow channel.

3. The fluid flow pathway of claim 2, wherein the body portion includes a body ring extending radially outwardly, the body ring includes a plurality of ring openings configured to allow for a flow of fluid from the plurality of grooves therethrough.

4. The fluid flow pathway of claim 3, wherein the base portion includes a plurality of base grooves in fluid communication with the plurality of ring openings.

5. The fluid flow pathway of claim 2, wherein the body portion extends from the base portion to a conical body tip.

6. The fluid flow pathway of claim 1, wherein a groove of the plurality of grooves is defined by opposing groove sidewalls having a selected groove angle therebetween and converging at the groove apex.

7. The fluid flow pathway of claim 6, wherein the groove angle is selected such that liquid phase fluid flow expels vapor phase fluid flow from the plurality of grooves and into the main channel.

8. The fluid flow pathway of claim 1, further comprising an inlet header to which the flow channel is connected at the inlet end of the flow channel.

9. The fluid flow pathway of claim 1, wherein the porous insert is formed from a plurality of micro-sized particles bonded together via, one of sintering or by one or more additive manufacturing processes.

10. A heat exchanger, comprising:
one or more fluid flow networks, each fluid flow network including a plurality of flow channels having an inlet end and an outlet end, at least one flow channel of the plurality of flow channels including:
a plurality of grooves extending in a lengthwise direction along an interior of the flow channel, each groove extending from a groove base to a groove apex radially outboard of the groove base; and
a main channel defined radially between the groove bases of the plurality of grooves;
an inlet header to which each inlet end is installed;
an outlet header to which each outlet end is installed at a respective header channel; and
a porous insert disposed between the flow channel and the header channel to regulate a flow of fluid into the outlet header from the flow channel.

11. The heat exchanger of claim 10, wherein the porous insert includes:
a base portion installed to the header channel; and
a body portion installed into the outlet end of the flow channel;
wherein the body portion blocks the main channel of the flow channel.

12. The heat exchanger of claim 11, wherein the body portion includes a body ring extending radially outwardly, the body ring includes a plurality of ring openings configured to allow for a flow of fluid from the plurality of grooves therethrough.

13. The heat exchanger of claim 12, wherein the base portion includes a plurality of base grooves in fluid communication with the plurality of ring openings.

14. The heat exchanger of claim 11, wherein the body portion extends from the base portion to a conical body tip.

15. The heat exchanger of claim 10, wherein a groove of the plurality of grooves is defined by opposing groove sidewalls having a selected groove angle therebetween and converging at the groove apex.

16. The heat exchanger of claim 15, wherein the groove angle is selected such that liquid phase fluid flow expels vapor phase fluid flow from the plurality of grooves and into the main channel.

17. The heat exchanger of claim 10, wherein the porous insert is formed from a plurality of micro-sized particles bonded together via, one of sintering or by one or more additive manufacturing processes.

18. The heat exchanger of claim 10, further comprising a honeycomb material disposed between adjacent flow channels of the plurality of flow channels.

19. The heat exchanger of claim 10, further comprising one or more face sheets in thermal communication with the plurality of flow channels.

20. The heat exchanger of claim 10, wherein the one or more fluid flow networks is two fluid flow networks.
